(19) United States
(12) Patent Application Publication
(10) Pub. No.: US 2013/0254654 A1
(43) Pub. Date: Sep. 26, 2013

(54) APPARATUS AND METHOD FOR DATA SOURCE CONTROL CONVERSION

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: RONG-RONG PENG, Shenzhen (CN); YAO-HUA LIU, Shenzhen (CN); XIN LU, Shenzhen (CN); SHIH-FANG WONG, New Taipei (TW)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/706,412

(22) Filed: Dec. 6, 2012

(30) Foreign Application Priority Data
Mar. 23, 2012 (CN) 201210078862.7

(51) Int. Cl. G06F 17/22

(52) U.S. Cl. CPC G06F 17/2264
USPC 715/239

(57) ABSTRACT

A computerized method implemented by a computing device that converts two one-dimensional data source controls into a single two-dimensional data source control. A target webpage having at least two one-dimensional data source controls is loaded from a storage of the computing device. Reference information of a first control and a second control of the target webpage are acquired, and one-dimensional data source and columns of each of the first control and the second control are acquired according to the reference information. The first control and the second control are converted into the single two-dimensional data source control according to the one-dimensional data source and columns of each of the first control and the second control. The first control and the second control are deleted from the target webpage, and the two-dimensional data source control is displayed on the target webpage.

### BACKGROUND

1. Technical Field

Embodiments of the present disclosure relate generally to webpage design, and particularly to an apparatus and method for data source control conversion.

2. Description of Related Art

Many webpages include a plurality of data source controls. Controls binding data sources are defined as data source controls. For example, controls binding one-dimensional data source (e.g., one-dimensional array) are defined as one-dimensional data source controls. Controls binding two-dimensional data source (e.g., two-dimensional array) are defined as two-dimensional data source controls. For particular reasons, two one-dimensional data source controls of a webpage may need to be combined to a two-dimensional data source control binding a two-dimensional data source which is a Cartesian product of the two one-dimensional data sources of the two one-dimensional data source controls. However, redesigning of the webpage and development of a new two-dimensional data source control are required for combining the two one-dimensional data source controls, which is very inconvenient and time consuming. Therefore, there is room for improvement in the art.

### BRIEF DESCRIPTION OF THE DRAWINGS

FIG. 1 is a schematic block diagram illustrating one embodiment of a computing device including a control conversion system.

FIG. 2 is a schematic diagram of an example of a webpage including two one-dimensional controls.

FIG. 3 is a schematic diagram of a two-dimensional control converted from the two one-dimensional controls of FIG. 2.

FIG. 4 is a flowchart of one embodiment of a method for converting two separate one-dimensional controls into a two-dimensional control using the control conversion system of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

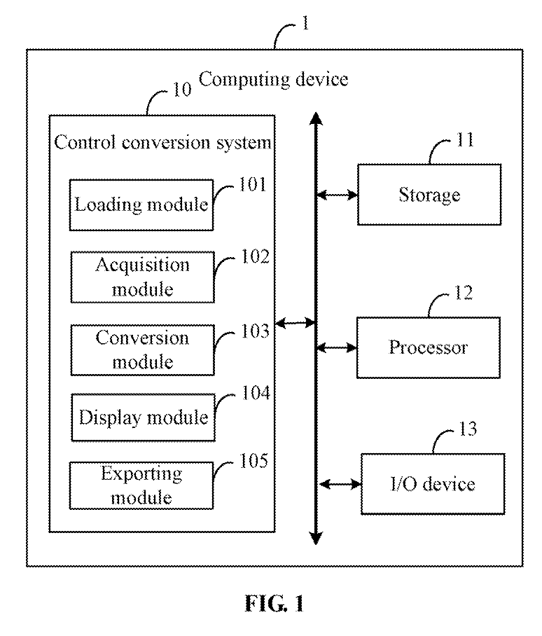

FIG. 1 is a schematic diagram illustrating one embodiment of a computing device 1. In the embodiment, the computing device 1 includes a control conversion system 10, a storage 11, a processor 12, and at least one input/output (I/O) device 13. In one embodiment, the computing device 1 may be, for example, a computer or a web server, which is used to develop and design webpages, including controls. FIG. 1 is only one example of the computing device 1, and the computing device 1 can include more or fewer components than those shown in the embodiment, or have a different configuration of the components.

The control conversion system 10 may include a plurality of programs in the form of one or more computerized instructions stored in the storage 11 and executed by the processor 12 to perform operations of the computing device 1. In the embodiment, the control conversion system 10 includes a loading module 101, an acquisition module 102, a conversion module 103, a display module 104, and an exporting module 105.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

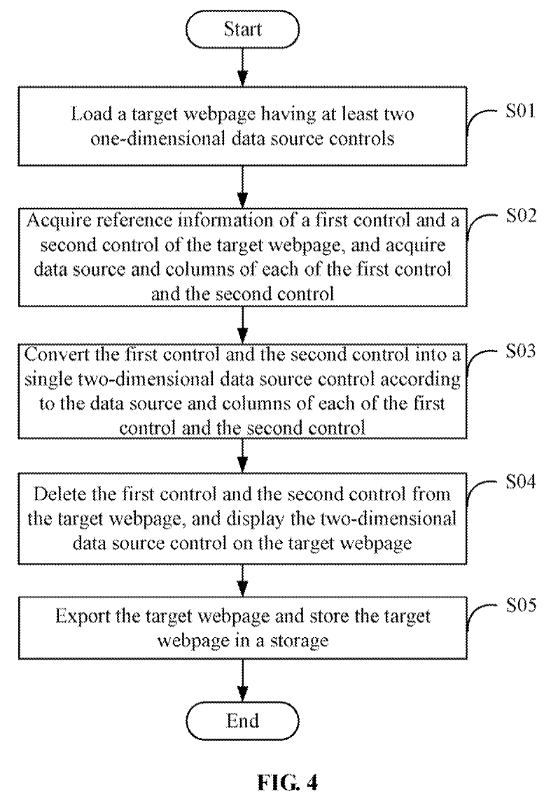

Referring to FIG. 4, a flowchart of one embodiment of method for converting two independent one-dimensional data source controls of a webpage into a two-dimensional data source control using the control conversion system of the computing device 1 of FIG. 1 is shown. Depending on the embodiment, additional steps may be added, others removed, and the ordering of the steps may be changed.

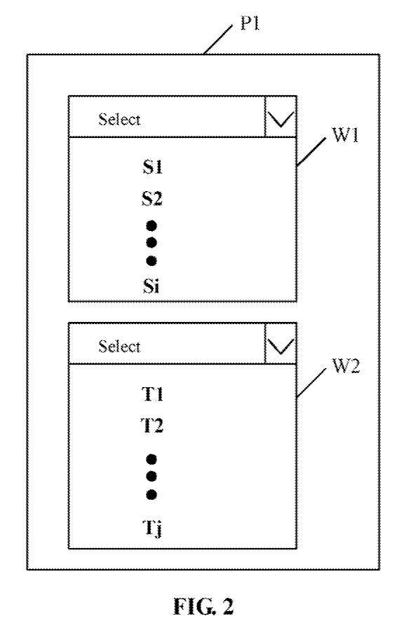

In step S01 the loading module 101 loads a target webpage having at least two separate one-dimensional data source controls. In one example, as shown in FIG. 2, a target webpage P1 includes a control W1 and a control W2 which are each a one-dimensional data source control and need to be converted into a single two-dimensional control. The control W1 is bound to a one-dimensional data source {S1, S2, . . . , Si}. The control W2 is bound to a one-dimensional data source {T1, T2, . . . , Tj}. The data source {S1, S2, . . . , Si} and {T1, T2, . . . , Tj} are respectively displayed through the control W1 and the control W2, which a user can select. The target webpage is loaded from the storage 11 which stores a plurality of webpages.

In step S02, the acquisition module 102 acquires reference information of a first control and a second control of the target webpage, and acquires one-dimensional data source and columns of each of the first control and of the second control according to the reference information of the first control and of the second control. In the embodiment, both the first control and the second control are one-dimensional controls (e.g., the control W1 and W2 of FIG. 2) to be converted into a single two-dimensional data source control. The reference information includes a name and/or identification (ID) of each of the first control and the second control, which are inputted by the user using the I/O device 13 (e.g., a keyboard). The one-dimensional data source and columns of each of the first control and the second control may be acquired by searching a source code file of the target webpage according to the acquired reference information. The source code file of the target webpage is also stored in the storage 11.

In step S03, the conversion module 103 converts the first control and the second control into a single two-dimensional data source control according to the one-dimensional data source and columns of each of the first control and the second control. In one example, it assumes that the first control (e.g., W1 of FIG. 2) includes i columns configured for displaying elements of data source S {S1, S2, . . . , Si} of the first control, and the second control (e.g., W2 of FIG. 2) includes j columns configured for displaying elements of data source T{T1, T2, . . . , Tj} of the second control. The conversion of the first control and the second control into one two-dimensional control is as follows.

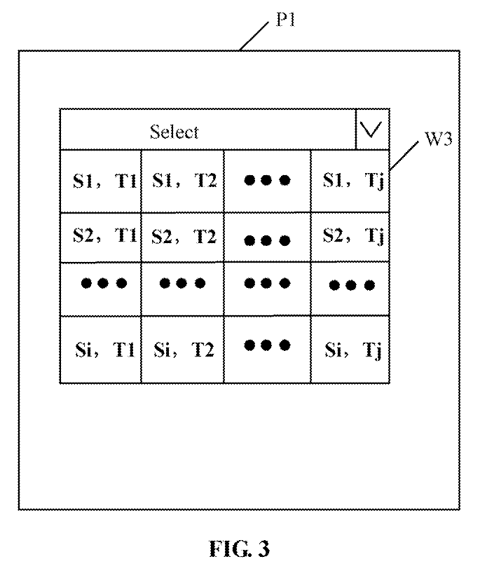

First, the conversion module 103 creates a data sheet having i rows and j columns. Then, the conversion module 103 calculates a Cartesian product of the data source S of the first control and the data source T of the second control, to obtain a two-dimensional data source D{(S1, T1), (S1, T2) . . . (S1, Tj); (S2, T1), (S2, T2) . . . (S2, Tj); . . . ; (S1, T1), (S1, T2) . . . (Si, Tj)}. Additionally, the conversion module 103 inputs each element (Si, Tj) of the two-dimensional data source D into a cell corresponding to the i^{th} row and j^{th} column of the data sheet, thereby generating a two-dimensional data source control binding the two-dimensional data source D. In one example, as shown in FIG. 3, a two-dimensional data source control W3 is the result of conversion from the control W1 and control W2 of FIG. 2.

In step S04, the display module 104 deletes the first control and the second control from the target webpage, and displays the generated two-dimensional data source control on the target webpage. In the embodiment, the two-dimensional data source control may be displayed at a location of the first control or a location of the second control on the target webpage, according to requirements. The location of the first control and the location of the second control is determined according to the source code file of the target webpage.

In step S05, the exporting module 105 exports the target webpage and stores the target webpage when the two-dimensional data source control is displayed on the target webpage.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized data source control conversion method using a computing device, the method comprising:
loading a target webpage having at least two one-dimensional data source controls from a storage of the computing device;
acquiring reference information of a first control and a second control of the target webpage, and acquiring one-dimensional data source and columns of each of the first control and the second control according to the reference information of the first control and of the second control, the first control and the second control being one-dimensional controls to be converted into a single two-dimensional data source control;
converting the first control and the second control into the single two-dimensional data source control according to the one-dimensional data source and columns of each of the first control and the second control; and
deleting the first control and the second control from the target webpage, and displaying the two-dimensional data source control on the target webpage.

2. The method according to claim 1, further comprising:
exporting the target webpage, and storing the target webpage in the storage when the two-dimensional data source control is displayed on the target webpage;

3. The method according to claim 1, wherein the converting step comprises:
creating a data sheet having i rows and j columns, wherein i indicates that the first control comprises i columns configured for displaying elements of one-dimensional data source S {S1, S2, . . . , Si}, and j indicates that the second control comprises j columns configured for displaying elements of one-dimensional data source T {T1, T2, . . . , Tj} of the second control;
calculating a Cartesian product of the one-dimensional data source S of the first control and the one-dimensional data source T of the second control, to obtain a two-dimensional data source D {(S1, T1), (S1, T2) . . . (S1, Tj); (S2, T1), (S2, T2) . . . (S2, Tj); . . . ; (S1, T1), (S1, T2) . . . (Si, Tj)}; and
inputting each element (Si, Tj) of the two-dimensional data source D into a cell corresponding to the i^{th} row and j^{th} column of the data sheet, to generate the single two-dimensional data source control that is bound to the two-dimensional data source D.

4. The method according to claim 1, wherein the one-dimensional data source and columns of each of the first control and the second control are acquired by searching a source code file of the target webpage according to the acquired reference information.

5. The method according to claim 1, wherein the reference information includes a name and/or identification (ID) of the first control and the second control, which are inputted using an input/output device of the computing device.

6. The method according to claim 1, wherein the single two-dimensional data source control is displayed at a location of the first control or a location of the second control on the target webpage.

7. A computing device, comprising:
a storage;
a processor;
one or more programs stored in the storage and executed by the processor, the one or more programs comprising:
a loading module that loads a target webpage having at least two one-dimensional data source controls from the storage;
an acquisition module that acquires reference information of a first control and a second control of the target webpage, and acquiring one-dimensional data source and columns of each of the first control and the second control according to the reference information of the first control and the second control, the first control and the second control being one-dimensional controls to be converted into a single two-dimensional data source control;
a conversion module that converts the first control and the second control into the two-dimensional data source control according to the one-dimensional data source and columns of each of the first control and the second control; and
a display module that deletes the first control and the second control from the target webpage, and displays the two-dimensional data source control on the target webpage.

8. The computing device according to claim 7, wherein the one or more programs further comprise:
an exporting module that exports the target webpage, and storing the target webpage in the storage when the single two-dimensional data source control is displayed on the target webpage.

9. The computing device according to claim 7, wherein the first control and the second control are converted into the two-dimensional data source control by:
creating a data sheet having i rows and j columns, wherein i indicates that the first control comprises i columns configured for displaying elements of one-dimensional data source S{S1, S2, . . . , Si}, and j indicates that the second control comprises j columns configured for displaying elements of one-dimensional data source T{T1, T2, . . . , Tj} of the second control;
calculating a Cartesian product of the one-dimensional data source S of the first control and the one-dimensional data source T of the second control, to obtain a two-dimensional data source D{(S1, T1), (S1, T2) . . . (S1, Tj); (S2, T1), (S2, T2) . . . (S2, Tj); . . . ; (S1, T1), (S1, T2) . . . (Si, Tj)}; and
inputting each element (Si, Tj) of the two-dimensional data source D into a cell corresponding to the i^{th} row and j^{th} column of the data sheet, to generate the single two-dimensional data source control that is bound to the two-dimensional data source D.

10. The computing device according to claim 7, wherein the one-dimensional data source and columns of each of the first control and the second control are acquired by searching a source code file of the target webpage according to the acquired reference information.

11. The computing device according to claim 7, wherein the reference information includes a name and/or identification (ID) of the first control and the second control, which are inputted using an input/output device of the computing device.

12. The computing device according to claim 7, wherein the two-dimensional data source control is displayed at a location of the first control or a location of the second control on the target webpage.
